(19) United States
(12) Patent Application Publication
(10) Pub. No.: US 2002/0042460 A1
(43) Pub. Date: Apr. 11, 2002

(54) Fender and a production method for the same

(76) Inventor: Yoshimichi Tanaka, Kobe-shi (JP)

Correspondence Address: BIRCH STEWART KOLASCH & BIRCH, PO BOX 747, FALLS CHURCH, VA, 22040-0747, US

(21) Appl. No.: 09/834,606

(22) Filed: Apr. 16, 2001

(30) Foreign Application Priority Data
Apr. 25, 2000 (JP) 2000-124703
Apr. 25, 2000 (JP) 2000-124702

(51) Int. Cl. C08K 5/00

(52) U.S. Cl. 524/81; 405/212; 114/219

(57) ABSTRACT

The present invention provides a fender formed from a rubber composition having a rate of change of compressibility R₋₃₀/R₂₃ of not more than 1.3 (where R₋₃₀ denotes a maximum reaction force at −30° C. as determined by compressive test and R₂₃ denotes a maximum reaction force at 23° C. as determined by compressive test) and/or a rate of change of compressibility R₆₀/R₂₃ of more than 0.90 (where R₂₃ denotes the maximum reaction force at 23° C. and R₆₀ denotes a maximum reaction force at 60° C.). The fender suffers no decrease in the reaction force in low-temperature and/or high-temperature conditions.

### BACKGROUND OF THE INVENTION

The present invention relates to a fender functioning as a shock absorber in the operation of docking a marine ship or the like or when the ship is moored to the pier. The invention further relates to a production method for the fender.

Various types of fenders have been known to the art which function as the shock absorber in the operation of docking the ship at the harbor or when the docked ship is moored to the pier. Above all, a solid-type fender with a heavy wall thickness formed of an elastic material, such as rubber, is widely used because of its simple construction having a shock absorbing function and resisting destruction.

The solid-type fender has a construction as shown in FIG. 9, for example, wherein a flat impact receiving portion 91 for receiving a compressive force (indicated by a hollow arrow in the figure) from the ship or the like is supported on its rear side by a pair of heavy-walled leg portions 92, 92 which are formed from a rubber material and disposed in a fan-like fashion.

Such a fender 9 exhibits a maximum reaction force R1 in a manner shown in FIG. 10 under ordinary temperature conditions. Specifically, when the impact receiving portion 91 receives the compressive force, the reaction force progressively increases as the leg portions 92, 92 are elastically deformed corresponding to the amount of compression increased to a given level, as indicated by a solid curve in FIG. 10. However, after the amount of compression exceeds the given level, the leg portions 92, 92 are buckled so that the reaction force normally tends to decline or stay at a certain level.

The solid-type fender is required to have such hardness, reaction force and other physical properties including tensile strength, breaking elongation and the like as to ensure the protection of the ship from destruction when collided with the ship. It has been a conventional practice to evaluate the performance of the fender based on a characteristic curve such as of a relationship between the amount of compression and the reactive force, the characteristic curve determined by compressing the fender at a given compression rate under room temperatures (ordinary temperature conditions). No consideration has been given to the variations of the reaction force associated with the variations of the environment, particularly the temperature, where the fender is actually used.

In reality, however, the fender is used under the temperatures varying from −30 to 60° C. depending upon geographical areas and the seasons. Accordingly, if the performance of the fender is evaluated based only on the characteristics determined under the ordinary room temperature conditions on the order of 23° C., the fender used under relatively low or high temperature conditions will encounter a problem.

The present inventors have investigated to find that when used under relatively low temperature conditions ranging from −30 to 23° C., the fender may sometimes exhibit a reaction force at −30° C. which is more than 1.5 times the reaction force measured under the room temperatures.

This point will be explained by way of a specific example shown in FIG. 11. FIG. 11 shows the fender 9, 1000 mm in height and 1000 mm in length, has an impact receiving plate 4, 2000 mm in width and 2000 mm in length, mounted thereto by means of a frame fixing bolt 5. This fender 9 is secured to place with an anchor bolt 6. The fender exhibits the following reaction force R and surface pressure P against the ship body under room temperatures:

Reaction force R=62.5 tonf

Surface pressure P=62.5 tonf/(2×2)m²=15.6 tonf/m²

Here, assuming that this fender is to be used for a ship with an allowable surface pressure of 20 tonf m², the general design defines an allowable reaction force R and surface pressure P under the temperature of −30° C. as follows:

Allowable surface pressure P<20/15.6=1.3 tonf/m²

Allowable reaction force R<62.5×1.3=81.3 tonf

That is, if the value of a maximum reaction force at −30° C. over a maximum reaction force at 23° C. is more than 1.3 times, the value exceeds the allowable surface pressure of the ship, leading to a possibility of destroying the ship.

On the other hand, when used under relatively high temperature conditions ranging from 23 to 60° C., a fender formed from some rubber material may exhibit a reaction force at 60° C. which is about 85% less than that measured at room temperatures. The decreased reaction force means a decreased energy absorbed by the fender so that the fender is incapable of effectively absorbing the kinetic energy of the docking ship. This can constitute a causative factor of an accident.

The energy absorption by the fender used under relatively high temperature conditions will be explained by way of the example of the fender installed as shown in FIG. 11. The fender exhibits the aforesaid reaction force R of 62.5 tonf and an amount of energy absorption E of 26.3 ton·m.

Here, the general design applies this fender to a ship with a docking energy of 25 ton·m. Assumed that the reaction force R₆₀ at 60° C. is lowered to 85% of the reaction force R₂₃ measured at the room temperature, the amount of energy absorption is correspondingly decreased. Thus, the reaction force and the amount of energy absorption are calculated as follows:

R₆₀=62.5×0.85=50 tonf

E₆₀=26.3×0.85=22.3 ton·m<25 tonf·m

As understood from the above, the marine fender designed to absorb the energy of 25 ton m is incapable of effectively absorbing the kinetic energy of the docking ship. This requires a modification of the design.

### SUMMARY OF THE INVENTION

As mentioned supra, the conventional fender is far from giving adequate consideration to the matter that the fender should function according to the variations of the environmental temperature. In view of this, it is an object of the invention to provide a fender reliably functioning under low temperature conditions and/or high temperature conditions as well as a production method for such a fender.

For achieving the above object, the present inventors have conducted various examinations of the rubber composition constituting the fender, trying to find how the materials of the rubber composition must be characterized in order to attain the fender adapted for the temperature variations. The inventors have found that it is effective to identify the ranges of temperature-dependent properties and an ordinary-temperature tanδ range as determined by dynamic stress test. The findings were further reviewed thereby to accomplish the present invention.

That is, the invention includes the followings:

1) A fender formed from a rubber composition, wherein the rubber composition has a rate of change of compressibility R₋₃₀/R₂₃ of not more than 1.3 (where R₋₃₀ denotes a maximum reaction force at −30° C. as determined by compressive test and R₂₃ denotes a maximum reaction force at 23° C. as determined by compressive test) and/or a rate of change of compressibility R₆₀/R₂₃ of more than 0.90 (where R₂₃ denotes the maximum reaction force at 23° C. and R₆₀ denotes a maximum reaction force at 60° C.);

2) The fender according to the above (1) wherein the rubber composition has the rate of change of compressibility R₋₃₀/R₂₃ of not more than 1.3 (where R₋₃₀ denotes the maximum reaction force at −30° C. as determined by compressive test and R₂₃ denotes the maximum reaction force at 23° C. as determined by compressive test), thus imparting the fender with a sufficient compressive energy absorptivity for functioning as a shock absorber in a low-temperature range;

3) The fender according to the above (2) wherein the rubber composition has:

(i) a rate of change of rigidity modulus G₋₃₀/G₂₃<1.38 and a tanδ<0.07 as determined by dynamic shearing test (where G₋₃₀ and G₂₃ denote dynamic moduli of rigidity at −30° C. and at 23° C., respectively, as measured under the conditions of a frequency at 0.3 Hz and a displacement of 2.5 mm); and

(ii) a rate of change of elasticity modulus E*₋₃₀/E*₂₃<2.3 and tanδ<0.10 as determined by dynamic tensile test (where E*₋₃₀ and E*₂₃ denote dynamic moduli of elasticity in tension at −30° C. and at 23° C., respectively, as measured under the conditions of a frequency at 10 Hz and a displacement of 50 μm);

4) The fender according to the above(1) wherein the rubber composition has the rate of change of compressibility R₆₀/R₂₃ of more than 0.90 (where R₂₃ denotes the maximum reaction force at 23° C. and R₆₀ denotes the maximum reaction force at 60° C.), thus imparting the fender with a sufficient compressive energy absorptivity for functioning as a shock absorber in a high-temperature range;

5) The fender according to the above (4) wherein the rubber composition has:

(i) a rate of change of rigidity modulus G₆₀/G₂₃>0.9 and tanδ<0.11 as determined by dynamic shearing test (where G₆₀ and G₂₃ denote dynamic moduli of rigidity at 60° C. and at 23° C., respectively, as measured under the conditions of a frequency at 0.3 Hz and a displacement of 2.5 mm); and

(ii) a rate of change of elasticity modulus E*₆₀/E*₂₃>0.7 and tanδ<0.14 as determined by dynamic tensile test (where E*₆₀ and E*₂₃ denote dynamic moduli of elasticity intension at 60° C. and at 23° C., respectively, as measured under the conditions of a frequency at 10 Hz and a displacement of 50 μm);

6) The fender according to the above (1) wherein the rubber composition contains 20 to 80 parts by weight of carbon black and 0 to 20 parts by weight of softener based on 100 parts by weight of base rubber material; and

7) A method for producing a fender from a rubber composition as a base material, wherein the rubber composition is prepared as an elastic base material and has a rate of change of compressibility R₋₃₀/R₂₃ of not more than 1.3 (where R₋₃₀ denotes a maximum reaction force at −30° C. as determined by compressive test and R₂₃ denotes a maximum reaction force at 23° C. as determined by compressive test) and a rate of change of compressibility R₆₀/R₂₃ of more than 0.90 (where R₂₃ denotes the maximum reaction force at 23° C. and R₆₀ denotes a maximum reaction force at 60° C.).

The fender of the invention may preferably have a rate of change of compressibility R₀/R₂₃≦1.05 (where Ro denotes a maximum reaction force at 0° C. as determined by compressive test and R₂₃ means the same as the above.

In the fender of the present invention wherein the rubber composition has the rate of change of compressibility R₋₃₀/R₂₃<1.3 (where R₋₃₀ denotes the maximum reaction force at −30° C. as determined by compressive test and R₋₂₃ denotes the maximum reaction force at 23° C. as determined by compressive test), the increase of the reaction force upon compression is suppressed in cold areas with temperatures of −30° C. and the like. Hence, the fender is able to exhibit the shock absorbing function as designed. Accordingly, when collided with the ship under low-temperature conditions, the inventive fender will not suffer the loss of shock absorptivity, which is experienced in the conventional fender, thus protecting the ship from destruction.

On the other hand, in the fender of the present invention wherein the rubber composition has the rate of change of compressibility R₆₀/R₂₃>0.90 (where R₂₃ denotes the maximum reaction force at 23° C. and R₆₀ denotes the maximum reaction force at 60° C.), the maximum reaction force equivalent to that at room temperatures can be attained under high-temperature conditions. That is, the fender is able to exhibit the shock absorbing function as designed under high-temperature conditions. Hence, the inventive fender can prevent an accident resulting from the inability to effectively absorb the impact energy from the ship, the inability suffered by the conventional fender.

In order to permit the fender to exhibit the shock absorbing function under high-temperature conditions, there is a requirement of R₆₀/R₂₃>0.90 in terms of the rate of change of compressibility. However, there may preferably be an additional requirement of R₄₀/R₂₃>0.95 (where R₄₀ denotes a maximum reaction force at 40° C. and R₂₃ denotes the reaction force at 23° C.).

According to the invention, it is also possible to provide a fender having an effective compressive energy absorptivity over a wide temperature range of from low-temperature environment to high-temperature environment.

The inventive fender can be produced by selecting the types and mixing ratio of a rubber, carbon black, curing agent, cure accelerator and softener, and suitably combining these ingredients in a manner that the fender may be imparted with the mechanical properties of the aforesaid ranges. In particular, the concentrations of carbon black and the softener may preferably be selected from the range of 20 to 80 parts by weight and 0 to 20 parts by weight based on 100 parts by weight of the base rubber material, respectively, such that the fender may be imparted with the required mechanical properties.

### BRIEF DESCRIPTION OF THE DRAWINGS

FIG. 1 is a graph plotting compressibility, dynamic modulus of rigidity and tanδ of rubber compositions prepared in Examples 1 and 2 and Comparative Examples 1 to 3;

FIG. 2 is a graph plotting compressibility, dynamic modulus of elasticity in tension and tanδ of the rubber compositions of Examples 1 and 2 and Comparative Examples 1 to 3;

FIG. 3 is a graphical representation of characteristic curves showing temperature-dependent relationships between the amount of compression and reaction force of the rubber compositions prepared in Example 2 and Comparative Example 3;

FIG. 4 is a graph plotting compressibility, dynamic modulus of rigidity and tans of rubber compositions prepared in Examples 3 and 4 and Comparative Examples 4 and 5;

FIG. 5 is a graph plotting compressibility, dynamic modulus of elasticity in tension and tanδ of the rubber compositions prepared in Examples 3 and 4 and Comparative Examples 4 and 5;

FIG. 6 is a graphical representation of characteristic curves showing temperature-dependent relationships between the amount of compression and reaction force of the rubber composition prepared in Comparative Example 5;

FIG. 7 is a graphical representation of characteristic curves showing the temperature-dependent relationships between the amount of compression and reaction force of the rubber composition prepared in Example 4;

FIG. 8 is a schematic diagram showing a configuration of a miniature model of an LMD-type fender;

FIG. 9 is a schematic diagram showing an exemplary fender;

FIG. 10 is a graphical representation of a relationship between the amount of compression and reaction force of the fender; and

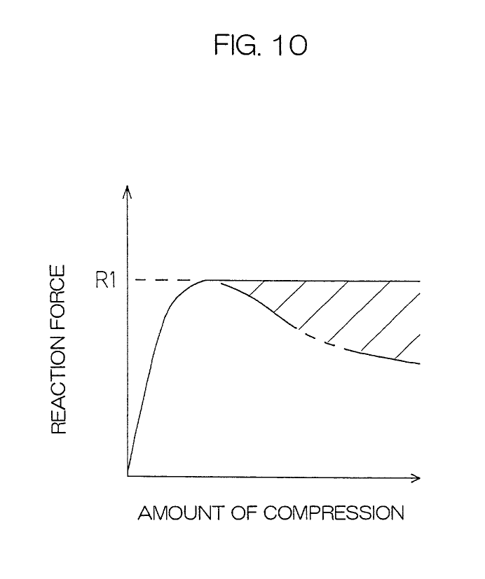

FIG. 11 is a schematic diagram showing an exemplary installation of the fender.

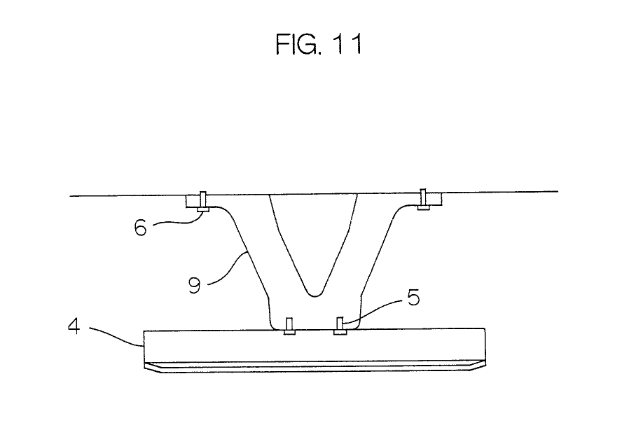

### DETAILED DESCRIPTION OF THE INVENTION

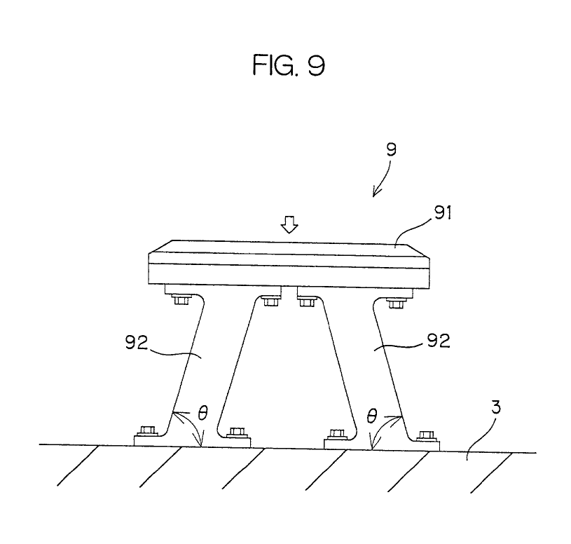

The present invention is directed to the fender, one example of which is shown in FIG. 9. Such a fender comprises the impact receiving portion 91 for receiving a compressive force, and a pair of leg portions 92, 92 for supporting the impact receiving portion on the back side thereof. The whole bodies of the leg portions are of a plate-like shape formed from an elastic rubber material and secured to a mounting surface in a fan-like fashion as inclined at an angle 75°≦θ<90° with respect to the surface. This fender has the following compression-reaction force characteristic curve. That is, when the impact receiving portion receives a compressive force, the pair of leg portions are elastically deformed to develop the reaction force. The reaction force increases as the amount of compression is increased to a given value. However, with the amount of compression exceeding the given value, the leg portions are buckled so that the reaction force declines. The leg portions 92, 92 may be directly connected with each other at their upper sides.

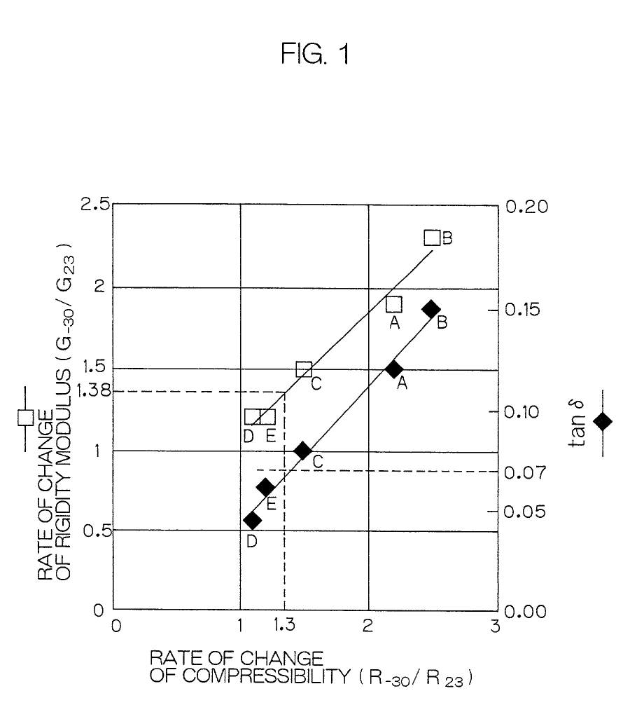

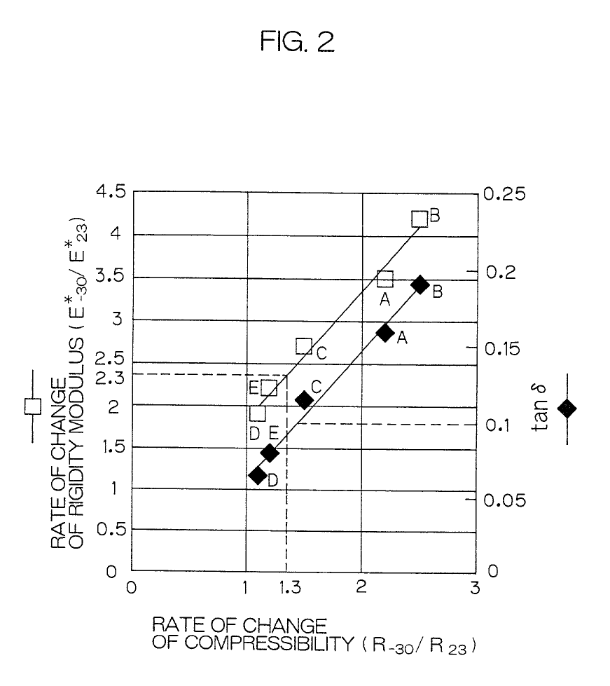

The fender of the present invention is applicable to solid-type fenders of various configurations including an elongated type, cylindrical type and the like. of the inventive fenders, an exemplary fender exhibiting a sufficient energy absorptivity under low-temperature conditions is cited and its mechanical properties are described with reference to FIGS. 1 and 2.

In Examples 1 and 2 and Comparative Examples 1 to 3, which will be described hereinlater, rubber compositions were prepared according to different formulations and then subjected to mechanical property tests according to the following procedures (see Table 1). FIG. 1 is a graph in which a rate of change of compressibility (R₋₃₀/R₂₃) is plotted on the abscissa whereas a rate of change of rigidity modulus (G₋₃₀/G₂₃) and tanδ, as determined by dynamic shearing test, are plotted on the ordinates. In the figure, plotted points ‘A’ to ‘E’ are based on data obtained in Comparative Examples 1 to 3 and Examples 1 and 2, respectively, whereas straight lines are determined by the least square method. Referring to the figure, the rubber composition for use in the inventive fender should satisfy a requirement including R₋₃₀/R₂₃<1.3, G₋₃₀/G₂₃<1.38 and tanδ<0.07. Incidentally, the rubber composition may preferably have a rate of change of compressibility R₀/R₂₃ of not more than 1.05 (or R₀/R₂₃≦1.05), with R₀ denoting the maximum reaction force at 0° C. as determined by compressive test.

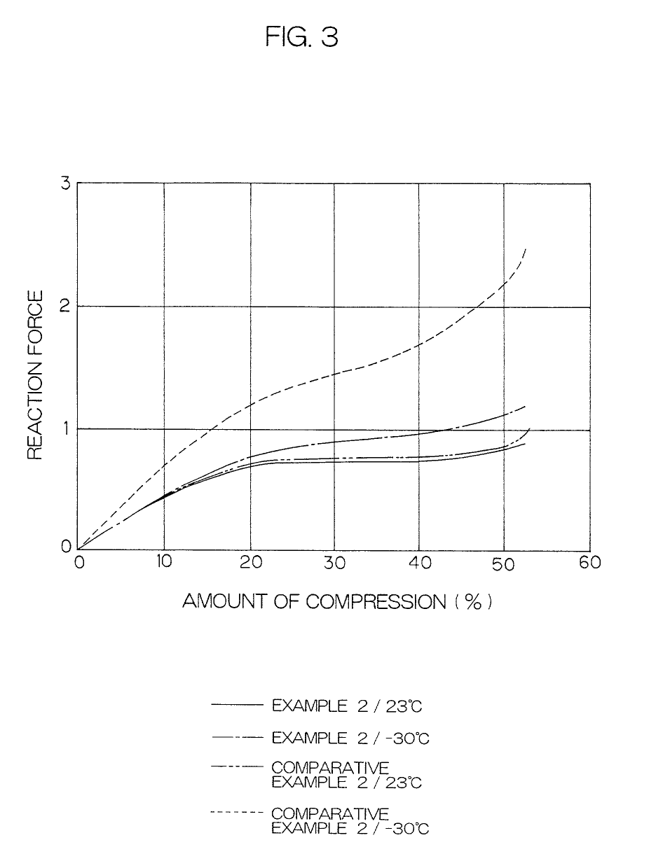

On the other hand, the rubber compositions of Examples 1 and 2 and Comparative Examples 1 to 3 were subjected to the following mechanical property tests. FIG. 2 is a graph in which the rate of change of compressibility (R₋₃₀/R₂₃) is plotted on the abscissa whereas a rate of change of elasticity modulus (E*₋₃₀/E*₂₃) and tanδ, as determined by dynamic tensile test, are plotted on the ordinates. In the figure, similarly to FIG. 1, plotted points ‘A’ to ‘E’ are based on the data obtained in Comparative Examples 1 to 3 and Examples 1 and 2, respectively, whereas straight lines are determined by the least square method. Referring to the figure, the rubber composition for use in the inventive fender should satisfy another requirement including R₀/R₂₃<1.05, R₋₃₀/R₂₃<1.3, E*₋₃₀/E*₂₃<2.3 and tanδ<0.10.

Where a fender is formed from the rubber composition satisfying the above two requirements, the resultant fender can exhibit the designed function even in cold areas with temperatures such as of −30° C. By way of an example, the rubber compositions of Example 2 and Comparative Example 2 will be described with respect to the relationship between the amount of compression and the reaction force as determined by compressive test, with reference to FIG. 3 graphically representing reaction force curves. As seen in the figure, the rubber composition of Comparative Example 2 presents a significant increase in the reaction force at −30° C. as the amount of compression increases. When compressed by 50%, this rubber composition presents a reaction force more than twice the reaction force at 23° C. Such a sharp increase in the reaction force means that the fender formed from this rubber composition may detrimentally fail to exhibit its designed function when collided with the ship, thus causing damage to the ship.

In contrast, the rubber composition of Example 2 according to the invention presents such reaction force curves at 23° C. and −30° C. as are not much different from each other if the amount of compression increases. This shows that even under low temperature conditions, this rubber composition permits the fender to function substantially the same way as under ordinary temperature conditions.

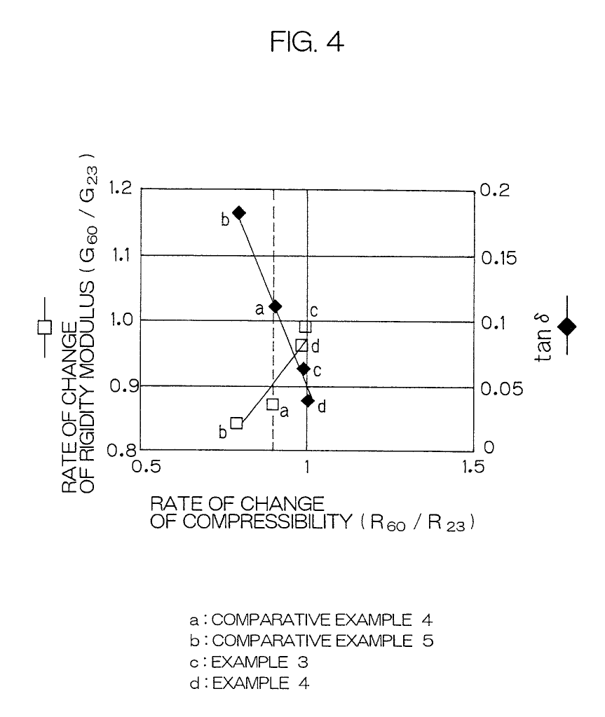

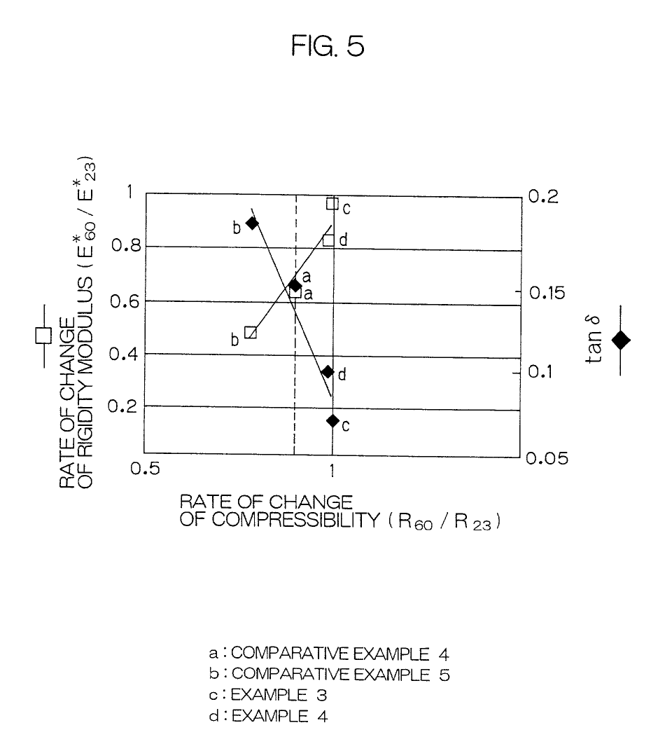

Of the inventive fenders, an exemplary fender exhibiting a sufficient energy absorptivity under high-temperature conditions is cited and its mechanical properties are described with reference to FIGS. 4 and 5.

In Comparative Examples 4 and 5 and Examples 3 and 4, which will be described hereinlater, rubber compositions were prepared according to different formulations and then subjected to mechanical property tests according to the following procedures (see Table 2). FIG. 4 is a graph in which a rate of change of compressibility (R₆₀/R₂₃) is plotted on the abscissa whereas a rate of change of rigidity modulus (G₆₀/G₂₃) and tanδ, as determined by dynamic shearing test, are plotted on the ordinates. In the figure, plotted points ‘a’ to ‘d’ are based on data obtained in Comparative Examples 4 and 5 and Examples 3 and 4, respectively, whereas straight lines are determined by the least square method. The rubber composition for use in the inventive fender should satisfy a requirement of R₆₀/R₂₃>0.90. As shown in FIG. 4, the rubber composition may preferably satisfy an additional requirement including G₆₀/G₂₃>0.9 and tanδ<0.11, as determined by dynamic shearing test.

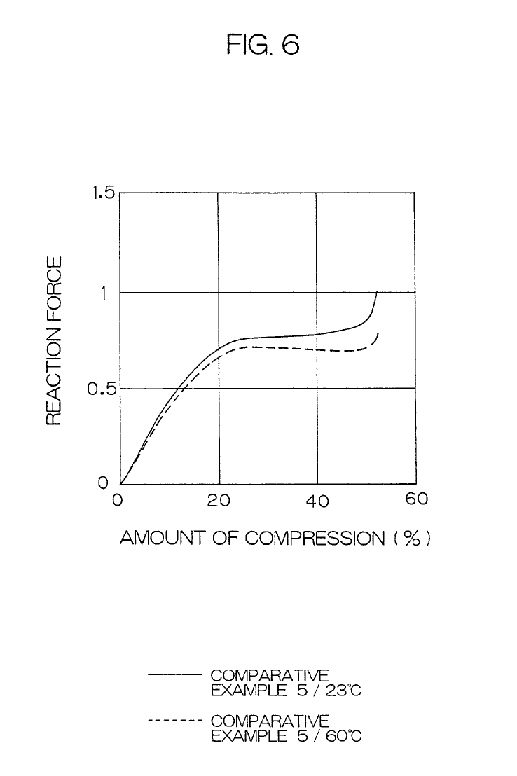

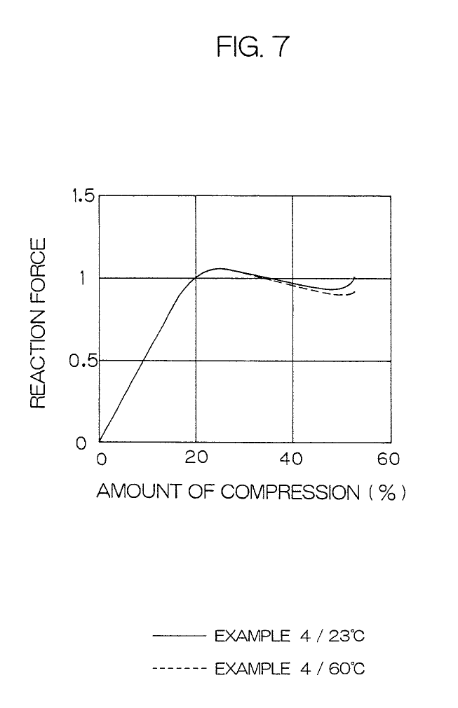

On the other hand, the rubber compositions of Comparative Examples 4 and 5 and Examples 3 to 4 were subjected to the following tests. FIG. 5 is a graph in which the rate of change of compressibility (R₆₀/R₂₃) is plotted on the abscissa whereas a rate of change of elasticity modulus (E*₆₀/E*₂₃) and tanδ, as determined by dynamic tensile test, are plotted on the ordinates. In the figure, similarly to FIG. 4, plotted points ‘a’ to ‘d’ are based on the data obtained in Comparative Examples 4 and 5 and Examples 3 and 4 (Table 2), respectively, whereas straight lines are determined by the least square method. The rubber composition for use in the inventive fender should satisfy a requirement of R₆₀/R₂₃>0.9 and preferably, as shown in FIG. 2, may satisfy an additional requirement including E*₆₀/E*₂₃>0.7 and tanδ<0.14, as determined by dynamic tensile test.

Where a fender is formed from the rubber composition satisfying the above two requirements, the resultant fender can exhibit the designed function even in hot areas with temperatures such as of 60° C. By way of an example, the rubber compositions of Comparative Example 5 and Example 4 will be described with respect to a relationship between the amount of compression and the reaction force as determined by compressive test, with reference to FIGS. 6 and 7 graphically representing reaction force curves. As seen in FIG. 6, the rubber composition of Comparative Example 4 has a tendency that a maximum reaction force at high temperature (60° C.) is smaller than a maximum reaction force at ordinary temperature (23° C.). As shown in FIG. 7, on the other hand, the rubber composition of Example 4 according to the invention presents such reaction force curves at 23° C. and 60° C. as are not much different from each other if the amount of compression increases. This means that even under high temperature conditions, this rubber composition permits the fender to function substantially the same way as under ordinary temperature conditions.

The mechanical properties of the rubber compositions of the invention were determined by original-state properties test, compressive test, dynamic shearing test and dynamic tensile test according to the following procedures.

[Original-State Properties Test]

Sample curing temperature: 140° C.

Tensile strength (MPa): Tensile test procedure for cured rubber as set forth in JIS K6251

Breaking elongation (%):Tensile test procedure for cured rubber as set forth in JIS K6251

Hardness: Hardness test procedure for cured rubber as set forth in JIS K6253 (using Type-A durometer)

[Compressive Test]

This test adopted a method using a miniature model of an LMD-type fender. Specifically, the method evaluates a lambda-type (LMD-type) fender by taking measurements of the compressibility of the miniature model of a similar configuration to that of the fender actually used. It is known that measurements of such a model are applicable to products actually used.

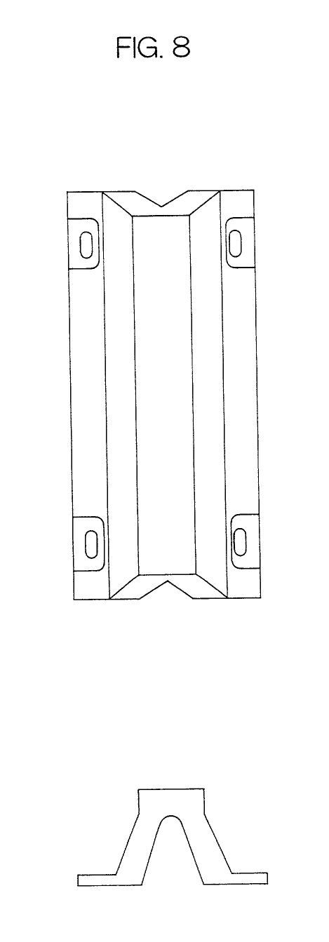

Sample: 100 mm(height)×200 mm(length) LMD-type fender miniature (see FIG. 8)

Curing conditions: press-curing at 145° C. for 90 minutes

Test procedure:

Tester: 5-ton tensile tester commercially available from Intesco Ltd.

Compression rate: 20 mm/min

Compressing conditions;

The sample was compressed in three cycles at intervals of three minutes, with a maximum amount of compression defined as 52.5% of the height of the sample. A performance value is defined as a mean value of the values at cycles 2 and 3. The maximum reaction force used as a property value means the greatest reaction force value within a specified range of amount of compression. [Dynamic Shearing Test]

Sample: Φ25 mm×5 mm(height)

Curing conditions: press-curing at 140° C. for 60 minutes

Test procedure:

Tester: Hydro-pulse dynamic shear tester commercially available from TOKYOKOKI.

Measuring conditions and expressions;

<Low-temperature Conditions>

The measurement was taken under conditions of frequency at 0.3 Hz, displacement of ±2.5 mm, and temperatures of −30° C. and 23° C. The modulus of rigidity G was determined using the following expression:

G=K×h/A

where K denotes a spring constant (kgf/cm), h denotes a height (cm) of the sample, and A denotes a cross section (cm²) of the sample.

Here, the rate of change of rigidity modulus is represented by G₋₃₀/G₂₃ provided that G₋₃₀ denotes a modulus of rigidity at −30° C. and G₂₃ denotes a modulus of rigidity at 23° C.

<High-temperature Conditions>

The modulus of rigidity was measured applying 50% shearing strain (displacement of 2.5 mm) to the sample at respective temperatures of 60° C. and 23° C. The modulus of rigidity G was determined using the following expression:

G=K×h/A

where K denotes a spring constant (kgf/cm), h denotes a height (cm) of the sample, and A denotes a cross section (cm²) of the sample.

Here, the rate of change of rigidity modulus is represented by G₆₀/G₂₃ provided that G₆₀ denotes a modulus of rigidity at 60° C. and G₂₃ denotes a modulus of rigidity at 23° C.

[Dynamic Tensile Test]

Sample: 4 mm(width)×35 mm(length)×2 mm(thickness)

Curing conditions: press-curing at 140° C. for 60 minutes

Procedure:

Tester; a viscoelastic spectrometer (DEV-V4 FT Rheospectrer commercially available from Rheology Co.) Measuring conditions;

<Low-temperature conditions>

The modulus of elasticity in tension E* and tanδ were measured under the conditions of frequency at 10 Hz, initial strain of 2 mm, displacement of 50 μm and temperatures of −30° C. and 23° C. Here, the rate of change of elasticity modulus in tension is represented by E*₋₃₀/E*₂₃ provided that E*₋₃₀ denotes a modulus of elasticity in tension at −30° C. and E*₂₃ denotes a modulus of elasticity in tension at 23° C.

<High-temperature Conditions>

The modulus of elasticity in tension E* was measured under the conditions of frequency at 10 Hz, initial strain of 2 mm, displacement of 50 μm and temperatures of 60° C. and 23° C. Here, the rate of change of elasticity modulus in tension is represented by E*₆₀/E*₂₃ provided that E*₆₀ denotes a modulus of elasticity in tension at 60° C. and E*₂₃ denotes the modulus of elasticity in tension at 23° C.

The fender of the invention may be produced only if a rubber composition is prepared in a manner that the composition may have the aforementioned mechanical properties. For instance, the rubber composition may be prepared using suitable type, amount and the like of a base rubber material and ingredients which are selected and combined together referring to the aforesaid mechanical properties as indeces.

Ordinary rubber components are usable as the base rubber material. Examples of a suitable base rubber material include natural rubber (NR), butadiene rubber (BR), styrene-butadiene rubber (SBR), isoprene rubber (IR), acrylonitrile-butadiene rubber (NBR), ethylene-propylene rubber (EPM), chloroprene rubber (CR), butyl rubber, urethane rubber, acrylic rubber, silicone rubber and the like. These base rubber materials may be used alone or in combination of two or more types. A particularly preferred blending ratio is 50 to 100 parts by weight of natural rubber and 50 to 0 parts by weight of butadiene rubber based on 100 parts by weight of the rubber component. With this blending ratio, there may be obtained a rubber-like elastic material which has properties (tensile strength, elongation, tear strength, compression set and the like) such as necessary for the compressive properties of the fender and which is less temperature-dependent as defined by the invention.

The rubber base material may be added with additives such as a curing agent, cure accelerator, cure acceleration adjuvant, reinforcing agent, softener, filler and the like, the types and concentrations of which are suitably adjusted such that the rubber composition may have such mechanical properties as defined by the invention.

In general, the rubber base material for use in fender often employs a single component of NR or SBR, and otherwise a blend of these materials. In order to attain the properties necessary for the fender, the rubber composition is adjusted for hardness or other mechanical properties by controlling the concentrations of carbon black, oil, curing agent, cure acceleration adjuvant and the like. In the production of the inventive fender, it is effective to decrease the concentration of SBR, which detrimentally increases the temperature dependency of the fender. In some cases, it is rather more effective to increase the concentration of BR. Since the influence of the reinforcing agent such as carbon black or the softener such as oil is significant, it is effective to decrease the concentrations of such additives as much as possible. However, there are demands for fenders of various properties. In a fender requiring a high reaction force, for example, the reinforcing agent must be present in great concentrations. In this case, BR may effectively be blended in concentrations of 0 to 50 parts by weight because if the fender is too rich in BR, lowered mechanical properties result. On the other hand, in a case where a fender with a low reaction force is able to serve the purpose, required properties can be attained by forming such a fender from a rubber composition containing 100 parts by weight of NR with the mixing ratio of the reinforcing agent and softener suitably adjusted. The formulation of the rubber composition may be adjusted in a manner to satisfy the required properties as well as to attain the aforesaid dynamic properties.

The mixing ratio of different types of rubber materials may suitably be selected, taking the effect of the resultant blend into consideration. For instance, if BR is increased in the proportion of the NR/BR ratio, the resultant rubber composition is improved in low-temperature properties and mechanical properties such as modulus, tensile strength and the like. Specifically, a suitable mixing ratio may be selected from the range of 50 to 100 wt % for NR and the range of 50 to 0 wt % for BR such that the rubber composition may impart the fender with the aforesaid properties (tear strength, compression set and the like).

Examples of a suitable curing agent include sulfur, organic sulfur compounds, organic peroxides and the like. Above all, sulfur is particularly preferred. Examples of a suitable cure accelerator include organic accelerators such as thiuram-base cure accelerators, dithiocarbamic acids, thiazoles and the like, and inorganic cure accelerators.

Examples of a suitable reinforcing agent include inorganic reinforcing agents such as carbon black, white carbon, zinc white, calcium carbonate, magnesium carbonate, talc, clay and the like; and organic reinforcing agents such as cumarone-indene resins, phenol resins, high styrene resins and the like. Above all, carbon black (e.g., HAF, GPF) is particularly preferred. Examples of a suitable softener include vegetable oils such as fatty acids, tall oil, asphaltic substances, paraffin wax and the like; mineral oils; synthetic oils and the like.

The rubber composition may preferably contain 20 to 80 parts by weight of carbon black based on 100 parts by weight of rubber base material while a mixing ratio of the softener may suitably be selected from the range of 0 to 20 parts by weight. The concentrations of the ingredients may be selected from the respective ranges such that the resultant rubber composition may have the aforesaid mechanical properties including the rate of change of compressibility, rate of change of rigidity modulus, and tanδ.

The fender may be molded by the known method. The curing conditions generally include the temperatures of 140 to 150° C. and the curing time of 1 to 10 hours. The press-curing process is preferably applied.

As mentioned supra, the invention provides the fender exhibiting excellent mechanical properties under low-temperature and/or high-temperature conditions as well as the method for fabricating such a fender. Additionally, the invention defines indeces of the mechanical properties of the rubber composition as references used in the production of the fender adapted for temperature variations. Therefore, the invention is advantageous in that choices of rubber compositions and their ingredients suitable for forming such a fender are provided.

That is, the invention also provides a method for selecting a rubber composition for use in fender wherein the ingredients of the rubber composition are selected based on the rate of change of compressibility R₋₃₀/R₂₃≦1.3 (where R₋₃₀ denotes the maximum reaction force at 30° C. as determined by compressive test and R₂₃ denotes the maximum reaction force at 23° as determined by compressive test) and/or the rate of change of compressibility R₆₀/R₂₃>0.9 (where R₂₃ denotes the maximum reaction force at 23° C. and R₆₀ denotes the maximum reaction force at 60° C.).

In the above selection method, it is further preferred to select the ingredients of the rubber composition based on the following mechanical characteristics: i) the rate of change of rigidity modulus G₋₃₀/G₂₃<1.38 and tanδ<0.07 as determined by dynamic shearing test (where G₋₃₀ and G₂₃ denote the dynamic moduli of rigidity measured at −30° C. and at 23° C., respectively, under the conditions of the frequency at 0.3 Hz and the displacement of 2.5 mm); and ii) the rate of change of elasticity modulus E*₋₃₀/E*₂₃<2.3 and tanδ<0.10 as determined by dynamic tensile test (where E*₋₃₀ and E*₂₃ denote the dynamic moduli of elasticity in tension measured at −30° C. and at 23° C., respectively, under the conditions of the frequency at 10 Hz and the displacement of 50 μm).

The above selection method further provides a method for selecting a rubber composition wherein the ingredients of the rubber composition are selected based on the mechanical properties including the rate of change of compressibility R₆₀/R₂₃>0.9 (where R₂₃ denotes the maximum reaction force at 23° C. and R₆₀ denotes the maximum reaction force at 60° C.). In this selection method, it is further preferred to select the ingredients of the rubber composition based on the following mechanical properties: i) the rate of change of rigidity modulus G₆₀/G₂₃>0.9 and tanδ<0.11 as determined by dynamic shearing test (where G₆₀ and G₂₃ denote the dynamic moduli of rigidity measured at 60° C. and 23° C., respectively, under the conditions of the frequency at 0.3 Hz and the displacement of 2.5 mm); and ii) the rate of change of elasticity modulus E*₆₀/E*₂₃>0.7 and tanδ<0.14 as determined by dynamic tensile test (where E*₆₀ and E*₂₃ denote the dynamic moduli of elasticity in tension measured at 60° C. and 23° C., respectively, under the conditions of the frequency at 10 Hz and the displacement of 50 μm).

### EXAMPLES

The invention will hereinbelow be described in more detail by way of reference to examples and comparative examples.

### Examples 1-2 and comparative Examples 1-3

Rubber compositions were prepared according to formulations shown in Table 1 as below. Each of the rubber compositions was prepared by blending using a Banburry mixer. A mixing procedure included the steps of: masticating a base rubber material for one minute; blending the base rubber material with carbon black, oil, stearic acid, zinc white and the like; kneading the resultant blend for three minutes before unloading the blend from the mixer; and admixing a curing agent such as sulfur to the kneaded blend using an open roll. Here, the carbon black was Diablack (HAF) commercially available from Mitsubishi Chemical Co., Ltd.; the aromatic oil was Diana Process AH40 commercially available from Idemitsu Kosan Co., Ltd.; and the cure accelerator was N-t-butyl-benzothiazoylylsulfenamide (Noccelar NS commercially available from OUCHI SHINKO CHEMICAL INDUSTRIAL CO., LTD.).

The resultant rubber compositions were examined by original-state properties test, compressive test, dynamic shearing test and dynamic tensile test in the aforementioned manners. The results are shown in Table 1.

TABLE 1

| | Ex. 1 | Ex. 2 | C. Ex. 1 | C. Ex. 2 | C. Ex. 3 |
|---|---|---|---|---|---|
| Ingredients | | | | | |
| NR | 100 | 70 | 70 | 70 | 85 |
| SBR | — | — | 30 | 30 | — |
| BR | — | 30 | — | — | 15 |
| Carbon black | 25 | 60 | 70 | 80 | 55 |
| Aromatic oil | 10 | 5 | 5 | 20 | 5 |
| Sulfur | 1 | 2.2 | 2.2 | 2.1 | 2 |
| Cure accelerator | 1.3 | 1.4 | 1.3 | 1 | 1.1 |
| Original state properties | | | | | |
| Hardness | 40 | 68 | 73 | 69 | 70 |
| Tensile strength (MPa) | 22 | 24 | 23 | 21 | 24 |
| Breaking elongation (%) | 780 | 410 | 360 | 450 | 480 |
| Compressive test (LMD) | | | | | |
| R₋₃₀/R₂₃ | 1.1 | 1.2 | 2.2 | 2.5 | 1.5 |
| Dynamic shearing test | | | | | |
| tanδ (23° C.) | 0.045 | 0.062 | 0.12 | 0.14 | 0.08 |
| G₋₃₀/G₂₃ | 1.2 | 1.2 | 1.9 | 2.1 | 1.5 |
| Dynamic tensile test | | | | | |
| tanδ (23° C.) | 0.065 | 0.08 | 0.16 | 0.191 | 0.115 |
| E*₋₃₀/E*₂₃ | 1.9 | 2.2 | 3.5 | 4.2 | 2.7 |

In Table 1 the symbols R₋₃₀/R₂₃, G₋₃₀/G₂₃ and E*₋₃₀/E*₂₃ denote the same as in the foregoing.

The review on the data concludes that the rubber compositions of Examples 1 and 2 have effective mechanical properties for the production of an inventive fender A. Comparison between Examples 3-4 and Comparative Examples 4-5.

Rubber compositions were prepared according to formulations shown in Table 2 as below. Each of the rubber compositions was prepared by blending using the Banburry mixer. A mixing procedure included the steps of: masticating a base rubber material for one minute; blending the base rubber material with carbon black, oil, stearic acid, zinc white and the like; kneading the resultant blend for three minutes before unloading the blend from the mixer; and admixing a curing agent such as sulfur to the kneaded blend using the open roll. Here, the carbon black was Diablack (HAF) commercially available from Mitsubishi Chemical Co., Ltd.; the aromatic oil was Diana Process AH40 commercially available from Idemitsu Kosan Co., Ltd.; and the cure accelerator was N-t-butyl-benzothiazoylylsulfenamide (Noccelar commercially available from OUCHI SHINKO CHEMICAL INDUSTRIAL CO, LTD.).

The resultant rubber compositions were examined by original-state properties test, compressive test, dynamic shearing test and dynamic tensile test in the aforementioned manners. The results are shown in Table 2.

TABLE 2

| | C. Ex. 4 | C. Ex. 5 | Ex. 3 | Ex. 4 |
|---|---|---|---|---|
| Ingredients | | | | |
| NR | 70 | 70 | 100 | 70 |
| SBR | 30 | 30 | — | — |
| BR | — | — | — | 30 |
| Carbon black | 70 | 80 | 25 | 60 |
| Aromatic oil | 5 | 20 | 10 | 5 |
| Sulfur | 2.2 | 2.1 | 1 | 2.2 |
| Cure accelerator | 1.3 | 1 | 1.3 | 1.4 |
| Original state properties | | | | |
| Hardness | 73 | 69 | 40 | 68 |
| Tensile strength (MPa) | 23 | 21 | 22 | 24 |
| Breaking elongation (%) | 360 | 450 | 780 | 410 |
| Compressive test (LMD) | | | | |
| R₆₀/R₂₃ | 0.9 | 0.79 | 1 | 0.99 |
| Dynamic shearing test | | | | |
| tanδ (23° C.) | 0.109 | 0.178 | 0.04 | 0.063 |
| G₆₀/G₂₃ | 0.87 | 0.84 | 0.99 | 0.97 |
| Dynamic tensile test | | | | |
| tanδ (23° C.) | 0.15 | 0.185 | 0.073 | 0.96 |
| E*₆₀/E*₂₃ | 0.65 | 0.5 | 0.97 | 0.83 |

In Table 2, the symbols R₆₀/R₂₃, G₆₀/G₂₃ and E*₆₀/E*₂₃ denote the same as in the foregoing.

The review on the results show that the rubber compositions of Comparative Examples 4 and 5 have the R₆₀/R₂₃ values of 0.9 and 0.79, as determined using the LMD miniature model, so that fenders employing these rubber compositions may present R₆₀/R₂₃ values below the designed allowable range when used under the high-temperature conditions. Thus, when used for absorbing the kinetic energy of 25 ton^{-m} from the ship, the fenders cannot effectively absorb the kinetic energy of the colliding ship. In contrast, the rubber compositions of Examples 3 and 4 have the R₆₀/R₂₃ values of 1 and 0.99 as determined using the LMD miniature model, showing little change in the compressibility. Hence, there is no fear that the designed properties entail a problem.

As mentioned supra and shown in FIG. 4, in order to limit the decrease of the maximum reaction force to not more than 0.1 as determined by the compressive test at 60° C., a design may be made such that the G₆₀/G₂₃ value is more than 0.9 and the tanδ at 23° C. is less than 0.11. Similarly, as shown in FIG. 5, in order to limit the decrease of the maximum reaction force as determined by the compressive test, a design may be made such that the E*₆₀/E*₂₃ value is more than 0.7 and the tanδ at 23° C. is less than 0.14.

The disclosure of Japanese patent application Nos. 2000-124703 and 2000-124702, filed on Apr. 25, 2000, is incorporated herein by reference.

What is claimed is:

1. A fender formed from a rubber composition, wherein said rubber composition has a rate of change of compressibility R₋₃₀/R₂₃ of not more than 1.3 (where R₋₃₀ denotes a maximum reaction force at −30° C. as determined by compressive test and R₂₃ denotes a maximum reaction force at 23° C. as determined by compressive test) and/or a rate of change of compressibility R₆₀/R₂₃ of more than 0.90 (where R₂₃ denotes the maximum reaction force at 23° C. and R₆₀ denotes a maximum reaction force at 60° C.).

2. The fender according to claim 1, wherein said rubber composition has the rate of change of compressibility R₋₃₀/R₂₃ of not more than 1.3 (where R₋₃₀ denotes the maximum reaction force at −30° C. as determined by compressive test and R₂₃ denotes the maximum reaction force at 23° C. as determined by compressive test), thus imparting the fender with a sufficient compressive energy absorptivity for functioning as a shock absorber in a low-temperature range.

3. The fender according to claim 2, wherein said rubber composition has:
(i) a rate of change of rigidity modulus G₋₃₀/G₂₃<1.38 and tanδ<0.07 as determined by dynamic shearing test (where G₋₃₀ and G₂₃ denote dynamic moduli of rigidity at −30° C. and at 23° C., respectively, as measured under the conditions of a frequency at 0.3 Hz and a displacement of 2.5 mm); and
(ii) a rate of change of elasticity modulus E*₋₃₀/E*₂₃<2.3 and tanδ<0.10 as determined by dynamic tensile test(where E*₋₃₀ and E*₂₃ denote dynamic moduli of elasticity in tension at −30° C. and at 23° C., respectively, as measured under the conditions of a frequency at 10 Hz and a displacement of 50 μm).

4. The fender according to claim 1, wherein said rubber composition has the rate of change of compressibility R₆₀/R₂₃ of more than 0.90 (where R₂₃ denotes the maximum reaction force at 23° C. and R₆₀ denotes the maximum reaction force at 60° C.), thus imparting the fender with a sufficient compressive energy absorptivity for functioning as a shock absorber in a high-temperature range.

5. The fender according to claim 4, wherein said rubber composition has:
(i) a rate of change of rigidity modulus G₆₀/G₂₃>0.9 and tanδ<0.11 as determined by dynamic shearing test (where G₆₀ and G₂₃ denote dynamic moduli of rigidity at 60° C. and at 23° C., respectively, as measured under the conditions of a frequency at 0.3 Hz and a displacement of 2.5 mm); and
(ii) a rate of change of elasticity modulus E*₆₀/E*₂₃>0.7 and tanδ<0 .14 as determined by dynamic tensile test (where E*₆₀ and E*₂₃ denote dynamic moduli of elasticity in tension at 60° C. and at 23° C., respectively, as measured under the conditions of a frequency at 10 Hz and a displacement of 50 μtm).

6. The fender according to claim 1, wherein said rubber composition contains 20 to 80 parts by weight of carbon black and 0 to 20 parts by weight of softener based on 100 parts by weight of base rubber material.

7. A method for producing a fender from a rubber composition as a base material, wherein the rubber composition is prepared as an elastic base material and has a rate of change of compressibility R₋₃₀/R₂₃ of not more than 1.3 (where R₋₃₀ denotes a maximum reaction force at −30° C. as determined by compressive test and R₂₃ denotes a maximum reaction force at 23° C. as determined by compressive test) and a rate of change of compressibility R₆₀/R₂₃ of more than 0.90 (where R₂₃ denotes the maximum reaction force at 23° C. and R₆₀ denotes a maximum reaction force at 60° C.).
